(19) United States
(12) Patent Application Publication
(10) Pub. No.: US 2017/0229039 A1
(43) Pub. Date: Aug. 10, 2017

(54) ABACUS CALCULATION TYPE MENTAL ARITHMETIC LEARNING SUPPORT DEVICE, ABACUS CALCULATION TYPE MENTAL ARITHMETIC LEARNING SUPPORT PROGRAM, AND ABACUS CALCULATION TYPE MENTAL ARITHMETIC LEARNING SUPPORT METHOD

(71) Applicant: Digika Co., Ltd., Tokyo (JP)

(72) Inventor: Chika YAMAUCHI, Tokyo (JP)

(21) Appl. No.: 15/501,511

(22) PCT Filed: Aug. 14, 2015
(86) PCT No.: PCT/JP2015/072939

§ 371 Date: Feb. 3, 2017

(30) Foreign Application Priority Data
Sep. 5, 2014 (JP) 2014-181796

(51) Int. Cl. G09B 19/02; G06F 3/0484; G09B 5/06; G06F 3/0488

(52) U.S. Cl. CPC G09B 19/025; G06F 3/0488; G06F 3/04845; G09B 5/065; G06F 3/048

(57) ABSTRACT

There is provided an abacus calculation type mental arithmetic learning support device or the like which is also effective for strengthening a capacity for storing arrangement of beads in addition to a capacity for operating a bead of an abacus and is also suitable for measuring an abacus calculation type mental arithmetic capacity, and supports to learn abacus calculation type mental arithmetic by a calculation exercise for operating an abacus-like screen. With a structure in which an abacus-like operation screen is output to a touch panel of a computer and a state of a bead is changed based on an abacus calculation rule when the bead is selected by an operator so that the same calculation exercise as the abacus can be performed, the computer is operated to enable non-display of a change in the state of the bead in a calculation process and to display the state of the bead after the change in a stage in which a calculation ending operation is accepted. Moreover, it is preferable to perform non-display of a number to be an answer in each stage of the calculation process as well as a change in the arrangement of the beads.

### TECHNICAL FIELD

The present invention relates to an abacus calculation type mental arithmetic learning support device, an abacus calculation type mental arithmetic learning support program and an abacus calculation type mental arithmetic learning support method for supporting learning of abacus calculation type mental arithmetic by a calculation exercise in which an abacus-like screen is operated.

### BACKGROUND ART

An abacus is a calculation tool which has been used earlier, and a Japanese type abacus having one five-bead and four one-beads arranged in one digit to represent the number of respective digits spreads widely to be a standard in the world. By spread of an electronic apparatus such as an electronic calculator or a personal computer, a demand for an abacus as a calculation tool is reduced. In many cases, however, a person having a high skill for an abacus is also excellent in a capacity of mental arithmetic without using the abacus. As a method of strengthening a mental calculation ability, attention has been paid to abacus calculation type mental arithmetic for mentally imagining an abacus to perform mental arithmetic.

There are disclosed the invention (see Patent Document 1) related to a system for displaying arrangement of beads of an abacus in a calculation process to imagine the beads of the abacus, thereby supporting mental arithmetic learning in calculation in note of the effects for strengthening the mental arithmetic capacity of the abacus, the invention (see Patent Document 2) related to a program to be utilized for learning an abacus and training a mental arithmetic capacity by displaying the abacus on a screen of a tablet type computer using a touch panel method which has spread rapidly in recent years, and the like.

### PRIOR ART DOCUMENT

### Patent Document

Patent Document 1: Japanese Laid-Open Patent Publication No. 2002-72859

Patent Document 2: Japanese Laid-Open Patent Publication No. 2012-256036

### SUMMARY OF THE INVENTION

### Problems to be Solved

In order to learn abacus calculation type mental arithmetic, it is necessary to cultivate two capacities including an “operation” for precisely moving beads in adaptation to questioning and “memory” for memorizing the arrangement of beads after the movement. Referring to the invention related to the mental arithmetic learning support system disclosed in the Patent Document 1, however, an input operating method is different from that of an abacus. For this reason, an “operation” cannot be trained, and furthermore, the arrangement of the beads in the calculation process is always maintained to be displayed. Therefore, sufficient effects for the training of the “memory” are expected with difficulty.

Referring to the invention related to the abacus learning program disclosed in the Patent Document 2, an abacus-like screen is displayed to move the beads based on contact positions of fingers with the screen. Therefore, it is supposed that the invention can be used for training the “operation”. However, the movement of the beads through the operation is output to the screen. Referring to the invention, similarly, the arrangement of the beads in the calculation process is displayed on the screen. In the same manner as the invention disclosed in the Patent Document 1, therefore, sufficient effects for training the “memory” are expected with difficulty.

As described in these inventions, referring to the method of performing calculation in the state in which the arrangement of the beads in the calculation process is displayed, it is impossible to objectively grasp whether an operator simply performs the calculation while recognizing the number of the beads while seeing the arrangement of the beads displayed on the screen or can perform the calculation while mentally imagining the arrangement of the beads. For this reason, there is such a limit that the inventions cannot be used for measuring the abacus calculation type mental arithmetic capacity.

The present invention has been made to cope with the problems and has an object to provide an abacus calculation type mental arithmetic learning support device, an abacus calculation type mental arithmetic learning support program and an abacus calculation type mental arithmetic learning support method which are effective for strengthening a capacity for “memorizing” the arrangement of beads in addition to a capacity for “operating” the beads of an abacus and are suitable for measuring an abacus calculation type mental arithmetic capacity, and support learning of the abacus calculation type mental arithmetic by a calculation exercise in which an abacus-like screen is operated.

### Means for Solving the Problems

The present invention provides a structure in which an abacus-like operation screen is output to a touch panel of a computer and a state of beads is changed based on an abacus calculation rule when the beads are selected by an operator, and the same calculation exercises as those of the abacus can be thus performed. With the structure, a computer is operated to enable non-display of the change in the state of the beads in a calculation process and to display the state of the beads after the change in a stage in which a calculation ending operation is accepted. Consequently, the operator is promoted to perform calculation for mentally imaging arrangement of the beads. Thus, it is possible to bring training of “memory”, thereby enabling expectation of the effects for learning the abacus calculation type mental arithmetic, and furthermore, to enable use for measuring whether the arrangement of the beads can be mentally imagined by the operator depending on whether accurate calculation can be performed also in this state. If a number to be an answer in each stage in the calculation process is also non-displayed in addition to the change in the arrangement of the beads, moreover, the “memory” is further promoted for the operator. Therefore, the structure is suitable for strengthening a mental arithmetic capacity.

The present invention having the features described above can be specified as a first invention requiring that a change in a state of beads in a calculation process is non-displayed and a second invention requiring that two display modes including a performance mode and an exercise mode are provided and the change in the state of the beads in the calculation process is non-displayed when the performance mode is selected. According to the first invention, “memory” of an operator can be promoted in a calculation exercise. According to the second invention, it is possible to carry out learning adapted to a learning level of the operator by switching display and non-display. Therefore, the structure is more suitable for learning the abacus calculation type mental arithmetic.

In the present invention, it is sufficient that the abacus-like operation screen to be output to the touch panel can arrange one five-bead and four one-beads in one digit to represent the number of the respective digits in the same manner as in the abacus. It is not required that one vertically movable space bead area is provided for each of a five-bead region and a one-bead region as in an ordinary abacus. As a matter of course, therefore, the abacus-like operation screen according to the present invention also includes a shape having no space bead area in which positions of one five-bead and four one-beads are fixed as shown in examples of FIGS. 2 to 16.

The first invention solving the problems of the present application is directed to an abacus calculation type mental arithmetic learning support device including operation screen output means for outputting an abacus-like operation screen capable of recognizing selection of each bead to a touch panel, bead state storing means for determining and storing a state of each bead into an invalid or valid state based on an abacus calculation rule when accepting a calculation stating operation and then recognizing selection of any bead displayed on the operation screen, and bead state output means for outputting the state of the bead to the operation screen in such a manner that a difference in the state of the bead stored in the bead state storing means can be identified visually, the bead state output means maintaining a state in which the difference in the state of each bead stored in the bead state storing means cannot be identified visually on the operation screen before accepting the calculation ending operation from the calculation starting operation and outputting the state of each bead to the operation screen in such a manner that the difference in the state of each bead stored in the bead state soring means can be identified visually when accepting the calculation ending operation.

The first invention can also be characterized by calculation result output means for outputting a number to be determined from states of all of beads stored in the bead state storing means as a calculation result to the operation screen, the calculation result output means maintains a state in which a number to be determined from the states of all of the beads stored in the bead state storing means is not displayed on the operation screen before accepting the calculation ending operation from the calculation starting operation and outputs the number to be determined from the states of all of the beads stored in the bead state storing means as a calculation result to the operation screen when accepting the calculation ending operation.

The second invention solving the problem according to the present application is directed to an abacus calculation type mental arithmetic learning support device including operation screen output means for outputting an abacus-like operation screen capable of recognizing selection of each bead to a touch panel, display mode storing means for accepting and storing selection of a display mode, that is, an exercise mode or a performance mode, bead state storing means for determining and storing a state of each bead into an invalid or valid state based on an abacus calculation rule when accepting a calculation stating operation and then recognizing selection of any bead displayed on the operation screen, and bead state output means for outputting the state of the bead to the operation screen in such a manner that a difference in the state of the bead stored in the bead state storing means can be identified visually, the bead state output means outputting the state of the bead to the operation screen in such a manner that a difference in the state of the bead can be identified visually if the exercise mode is stored in the display mode storing means when the state of the bead stored in the bead state storing means is changed, maintaining a state in which a difference in the state of each bead stored in the bead state storing means cannot be identified visually on the operation screen if the performance mode is stored in the display mode storing means, and outputting the state of each bead to the operation screen in such a manner that the difference in the state of the bead stored in the bead state storing means can be identified visually even if either the exercise mode or the performance mode is stored in the display mode storing means when accepting the calculation ending operation.

The second invention can also be characterized by calculation result output means for outputting a number to be determined from the states of all of the beads stored in the bead state storing means as a calculation result to the operation screen, the calculation result output means outputting a number to be determined from states of all of the beads stored in the bead state storing means as a calculation result to the operation screen if the exercise mode is stored in the display mode storing means when the state of the bead stored in the bead state storing means is changed, maintaining a state in which the number to be determined from the states of all of the beads stored in the bead state storing means is not displayed on the operation screen if the performance mode is stored in the display mode storing means, and outputting the number to be determined from the states of all of the beads stored in the bead state storing means as a calculation result to the operation screen even if either the exercise mode or the performance mode is stored in the display mode storing means when accepting the calculation ending operation.

The present invention can also be characterized in that the bead state storing means determines and stores the state of the bead to be valid if the state of the selected bead is invalid and to be invalid if the state of the selected bead is valid when the selected bead is a five-bead, and determines and stores the state of the selected bead and a one-bead in the same digit placed in an upper position of the selected bead to be valid if the state of the selected bead is invalid, and the state of the selected bead and a one-bead in the same digit placed in a lower position of the selected bead to be valid if the state of the selected bead is invalid when the selected bead is a one-bead.

With the features, it is possible to determine the state of each bead based on the abacus calculation rule by simply recognizing which one of the beads is selected even if a difference in movement of the bead in an upper or lower direction cannot be detected by an operation on the touch panel.

The present invention can also be characterized by bead state initializing means for returning a state of each bead stored in the bead state storing means into initialization when accepting a predetermined operation for initializing a state of a bead including a new calculation starting operation, the bead state storing means determining and storing a state of each bead based on an abacus calculation rule when selection of any of the beads displayed on the operation screen is recognized after the calculation continuing operation is accepted with the state of each bead which is stored in the acceptance of the calculation ending operation set to be an origin if the calculation continuing operation is accepted after the calculation ending operation is accepted.

With the features, in the case in which the state of the bead in a middle stage in which a calculation result is non-displayed is to be confirmed, it is possible to cope with the confirmation by performing a calculation continuing operation after once carrying out the calculation ending operation or to cope with the case in which the calculation is further continued by using an answer of certain calculation.

The present invention can also be characterized by including operation sound output means for outputting, to a speaker, an operation sound corresponding to the selected bead when selection of any of the beads displayed on the operation screen is recognized after the calculation starting operation is accepted.

The present invention can also be characterized in that a computer is caused to include bead display changing means for temporarily changing a display state of the selected bead in such a manner that the selected bead can be identified visually when selection of any of the beads displayed on the operation screen is recognized after the calculation starting operation is accepted.

By having any of these features, also when the calculation is being performed with the state of the bead non-displayed, an operator himself (herself) can easily recognize which one of the beads is operated based on generation of a sound or a temporary change in the display state of the bead.

The present invention can also be specified as an invention related to an abacus calculation type mental arithmetic learning support program to be executed in the abacus calculation type mental arithmetic support device according to the present invention.

the invention related to the abacus calculation type mental arithmetic learning support system corresponding to the first invention is directed to an abacus calculation type mental arithmetic learning support program, wherein a computer for inputting/outputting information by using a touch panel is caused to function as operation screen output means for outputting an abacus-like operation screen capable of recognizing selection of each bead to the touch panel, bead state storing means for determining and storing a state of each bead into an invalid or valid state based on an abacus calculation rule when accepting a calculation stating operation and then recognizing selection of any bead displayed on the operation screen, and bead state output means for outputting the state of the bead to the operation screen in such a manner that a difference in the state of the bead stored in the bead state storing means can be identified visually, the bead state output means maintaining a state in which the difference in the state of each bead stored in the bead state storing means cannot be identified visually on the operation screen before accepting an operation for ending the calculation from an operation for starting the calculation and outputting the state of each bead to the operation screen in such a manner that the difference in the state of each bead stored in the bead state soring means can be identified visually when accepting the calculation ending operation.

The invention related to the abacus calculation type mental arithmetic learning support program corresponding to the second invention is directed to an abacus calculation type mental arithmetic learning support program, wherein a computer for inputting/outputting information by using a touch panel is caused to function as operation screen output means for outputting an abacus-like operation screen capable of recognizing selection of each bead to the touch panel, display mode storing means for accepting and string selection of a display mode, that is, an exercise mode or a performance mode, bead state storing means for determining and storing a state of each bead into an invalid or valid state based on an abacus calculation rule when accepting a calculation stating operation and then recognizing selection of any bead displayed on the operation screen, and bead state output means for outputting the state of the bead to the operation screen in such a manner that a difference in the state of the bead stored in the bead state storing means can be identified visually, the bead state output means outputting the state of the bead to the operation screen in such a manner that a difference in the state of the bead can be identified visually if an exercise mode is stored in the display mode storing means when the state of the bead stored in the bead state storing means is changed, maintaining a state in which a difference in the state of each bead stored in the bead state storing means cannot be identified visually on the operation screen if a performance mode is stored in the display mode storing means, and outputting the state of each bead to the operation screen in such a manner that the difference in the state of the bead stored in the bead state storing means can be identified visually even if either the exercise mode or the performance mode is stored in the display mode storing means when accepting the calculation ending operation.

Moreover, the invention related to the abacus calculation type mental arithmetic learning support program according to the present invention can also be specified as the invention related to an abacus calculation type mental arithmetic learning support program corresponding to each of the structures of the abacus calculation type mental arithmetic learning support device related to the present invention described above.

The present invention can also be specified as the invention related to an abacus calculation type mental arithmetic learning support method to be executed in accordance with the abacus calculation type mental arithmetic learning support device according to the present invention or the abacus calculation type mental arithmetic learning support program according to the present invention.

The invention related to the abacus calculation type mental arithmetic learning support method corresponding to the first invention is directed to an abacus calculation type mental arithmetic learning support method, the method including an operation screen outputting step of causing a computer for inputting/outputting information by using a touch panel to output an abacus-like operation screen capable of recognizing selection of each bead to the touch panel, a bead state storing step of causing the computer to determine and store a state of each bead into an invalid or valid state based on an abacus calculation rule when accepting a calculation stating operation and then recognizing selection of any bead displayed on the operation screen, and a bead state outputting step of causing the computer to output the state of the bead to the operation screen in such a manner that a difference in the state of the bead stored at the bead state storing step can be identified visually, at the bead state outputting step, the computer maintaining a state in which the difference in the state of each bead stored at the bead state storing step cannot be identified visually on the operation screen before accepting an operation for ending the calculation from the calculation starting operation and outputting the state of each bead to the operation screen in such a manner that the difference in the state of each bead stored at the bead state storing step can be identified visually when accepting the calculation ending operation.

The invention related to the abacus calculation type mental arithmetic learning support method corresponding to the second invention is directed to an abacus calculation type mental arithmetic learning support method, the method including an operation screen outputting step of causing a computer for inputting/outputting information by using a touch panel to output an abacus-like operation screen capable of recognizing selection of each bead to the touch panel, a display mode storing step of causing the computer to accept and store selection of a display mode, that is, an exercise mode or a performance mode, a bead state storing step of causing the computer to determine and store a state of each bead into an invalid or valid state based on an abacus calculation rule when accepting a calculation stating operation and then recognizing selection of any bead displayed on the operation screen, and a bead state outputting step of causing the computer to output the state of the bead to the operation screen in such a manner that a difference in the state of the bead stored at the bead state storing step can be identified visually, at the bead state outputting step, the computer is caused to output the state of the bead to the operation screen in such a manner that a difference in the state of the bead can be identified visually if an exercise mode is stored at the display mode storing step when the state of the bead stored at the bead state storing step is changed, to maintain a state in which a difference in the state of each bead stored in the bead state storing means cannot be identified visually on the operation screen if a performance mode is stored at the display mode storing step, and to output the state of each bead to the operation screen in such a manner that the difference in the state of each bead stored at the bead state storing step can be identified visually even if either the exercise mode or the performance mode is stored at the display mode storing step when accepting the calculation ending operation.

Moreover, the invention related to the abacus calculation type mental arithmetic learning support method according to the present invention can also be specified as the invention related to the abacus calculation type mental arithmetic learning support method to be executed by the abacus calculation type mental arithmetic learning support device or the abacus calculation type mental arithmetic learning support program corresponding to each of the structures of the abacus calculation type mental arithmetic learning support device related to the present invention described above.

### Effect of the Invention

According to the present invention, it is possible to easily perform a calculation exercise for learning an abacus calculation type mental arithmetic to strengthen two capacities including an “operation” of beads of an abacus and “memory” of arrangement of the beads by using a touch panel tablet type computer which has spread rapidly in recent years or a special purpose machine including a touch panel. Moreover, it is also possible to confirm whether the arrangement of the beads can be mentally imagined in a mental arithmetic process. Therefore, the present invention is suitable for measuring an abacus calculation type mental arithmetic capacity.

### BRIEF DESCRIPTION OF THE DRAWINGS

FIG. 1 is a block diagram showing an example of a structure of an abacus calculation type mental arithmetic learning support device according to the present invention.

FIG. 2 is a first view showing an example of an operation screen to be output in accordance with an abacus calculation type mental arithmetic learning support program according to the present invention.

FIG. 3 is a second view showing an example of the operation screen to be output in accordance with the abacus calculation type mental arithmetic learning support program according to the present invention.

FIG. 4 is a first view showing an example of a transition of the operation screen in an exercise mode to be output in accordance with the abacus calculation type mental arithmetic learning support program according to the present invention.

FIG. 5 is a second view showing an example of the transition of the operation screen in the exercise mode to be output in accordance with the abacus calculation type mental arithmetic learning support program according to the present invention.

FIG. 6 is a third view showing an example of the transition of the operation screen in the exercise mode to be output in accordance with the abacus calculation type mental arithmetic learning support program according to the present invention.

FIG. 7 is a fourth view showing an example of the transition of the operation screen in the exercise mode to be output in accordance with the abacus calculation type mental arithmetic learning support program according to the present invention.

FIG. 8 is a fifth view showing an example of the transition of the operation screen in the exercise mode to be output in accordance with the abacus calculation type mental arithmetic learning support program according to the present invention.

FIG. 9 is a first view showing an example of a transition of the operation screen in a performance mode to be output in accordance with the abacus calculation type mental arithmetic learning support program according to the present invention.

FIG. 10 is a second view showing an example of the transition of the operation screen in the performance mode to be output in accordance with the abacus calculation type mental arithmetic learning support program according to the present invention.

FIG. 11 is a third view showing an example of the transition of the operation screen in the performance mode to be output in accordance with the abacus calculation type mental arithmetic learning support program according to the present invention.

FIG. 12 is a fourth view showing an example of the transition of the operation screen in the performance mode to be output in accordance with the abacus calculation type mental arithmetic learning support program according to the present invention.

FIG. 13 is a fifth view showing an example of the transition of the operation screen in the performance mode to be output in accordance with the abacus calculation type mental arithmetic learning support program according to the present invention.

FIG. 14 is a first view showing an example of a transition of the operation screen to be output in the case in which a calculation continuing operation is performed in accordance with the abacus calculation type mental arithmetic learning support program according to the present invention.

FIG. 15 is a second view showing an example of the transition of the operation screen to be output in the case in which the calculation continuing operation is performed in accordance with the abacus calculation type mental arithmetic learning support program according to the present invention.

FIG. 16 is a third view showing an example of the transition of the operation screen to be output in the case in which the calculation continuing operation is performed in accordance with the abacus calculation type mental arithmetic learning support program according to the present invention.

FIG. 17 is a flowchart showing a processing flow according to a first embodiment of the abacus calculation type mental arithmetic learning support program in accordance with the present invention.

FIG. 18 is a first flowchart showing a processing flow according to a second embodiment of the abacus calculation type mental arithmetic learning support program in accordance with the present invention.

FIG. 19 is a second flowchart showing a processing flow according to the second embodiment of the abacus calculation type mental arithmetic learning support program in accordance with the present invention.

### MODE FOR CARRYING OUT THE INVENTION

Modes for carrying out the present invention will be described below in detail with reference to the drawings. The following description is only illustrative as an example of embodiments according to the present invention and the present invention is not restricted to the embodiments described herein. The present invention can be carried out by installing an abacus calculation type mental arithmetic learning support program according to the present invention into a storage medium to be provided in a tablet type computer, a smart phone or the like or providing the program in a storage medium of a server which is accessible from a network terminal or using an abacus calculation type mental arithmetic learning support device according to the present invention as a special device for abacus calculation type mental arithmetic learning.

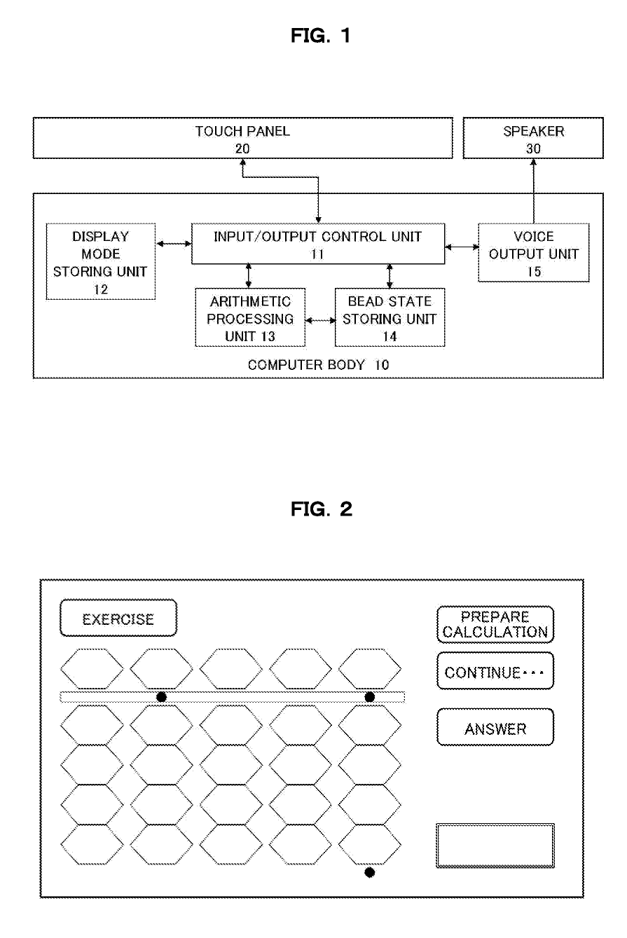

FIG. 1 shows an example of a structure of the abacus calculation type mental arithmetic learning support device according to the present invention. In FIG. 1, a computer body 10 corresponds to an abacus calculation type mental arithmetic learning support device having an abacus calculation type mental arithmetic learning support program according to the present invention. A general-purpose type computer such as a tablet type computer may be used for the computer body 10 or may be configured as an exclusive device specialized for an abacus calculation type mental arithmetic learning function.

The computer body 10 is connected to a touch panel 20 and a speaker 30. However, a structure thereof is not particularly restricted. These may be integrally configured like a general tablet type computer or may be configured with a part thereof separated. Alternatively, it is also possible to employ a structure in which the computer body 10 is configured as a server connected to a network and a network terminal to be used by an operator has touch panel 20 and a function for inputting/outputting information to/from the touch panel 20, and a function for transmitting/receiving information to/from the computer body 10 through the network.

In the computer body 10, all of an input/output control unit 11, an arithmetic processing unit 13 and a voice output unit 15 are functionally specified. A program corresponding to a function of each unit which is stored in an auxiliary storage device such as an HDD or an SSD provided in the computer body 10 is read onto a main memory of the computer body 10 and an arithmetic processing is executed by a CPU of the computer body 10 so that the function corresponding to each unit can be implemented.

Predetermined storage areas of the auxiliary storage device such as the HDD or the SSD to be provided in the computer body 10 are allocated to a display mode storing unit 12 and a bead state storing unit 14 in the computer body 10.

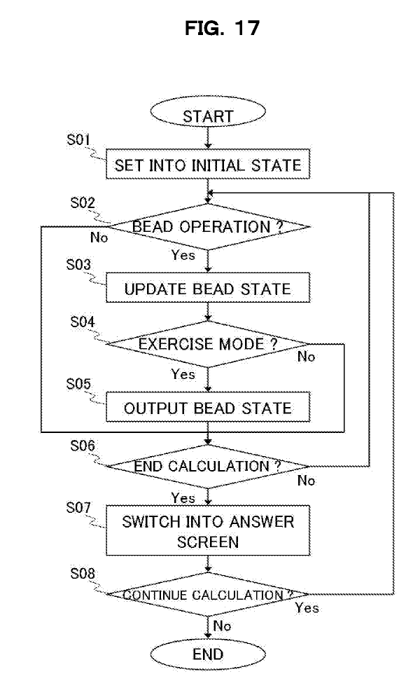

on the assumption of the structure described above, explanation will be given to a processing flow of the abacus calculation type mental arithmetic learning support program according to the present invention with reference to the examples of an operation screen shown in FIGS. 2 to 16 and flowcharts shown in FIGS. 17 to 19.

In the computer body 10, when the abacus calculation type mental arithmetic learning support program according to the present invention is called from the storage medium such as the HDD or the SSD in the computer body 10 and is started, the abacus-like operation screen illustrated in FIG. 2 is output to the touch panel 20 by the input/output control unit 11. In the operation screen, a vertical movable space bead area like an ordinary abacus is provided in neither of five-bead and one-bead regions. However, one five-bead and four one-beads are arranged in one digit to represent the number of the respective digits in the same manner as in an ordinary abacus. In addition to the beads arranged in such a shape, the operation screen is provided with a display mode selection button (a portion displayed as “exercise”) for selecting an exercise mode or a performance mode, a start button for a calculation starting operation (a portion displayed as “prepare calculation”), a continue button for a calculation continuing operation (a portion displayed as “continue . . . ”), an end button for a calculation ending operation (a portion displayed as “answer”), and furthermore, an answer display region for outputting the number of calculation results in a numeral (a region surrounded by a rectangle shown in a double line). Terms to be displayed on these buttons are not restricted to the examples shown herein. For example, referring to the display mode selection button for selecting the exercise mode or the performance mode, the exercise mode illustrated as “exercise” may be replaced with “abacus” indicative of abacus training and the performance mode illustrated as “performance” may be replaced with “mental arithmetic” indicative of mental arithmetic training. Moreover, it is also possible to employ a structure in which the continue button illustrated as “continue . . . ” is not provided and a function of the calculation continuing operation is not included.

Herein, all beads to be displayed on the operation screen are determined to be in either of states of ON (valid) and OFF (invalid), and the state of each of the beads is temporarily stored in the bead state storing unit 14. In an initial state, the states of all of the beads are OFF (invalid). When the input/output control unit 11 detects that the operator selects any of the beads over the touch panel 20, the related beads are determined to be switched into ON (valid) based on an abacus calculation rule and the state of each of the beads stored temporarily in the bead state storing unit 14 is updated to be ON (valid) on the assumption that the selected bead is moved over the abacus. When the input/output control unit 11 detects an operation for selecting any of the beads which is in a state of ON (valid), similarly, the related beads are determined to be switched into OFF (invalid) based on an abacus calculation rule and the state of each of the beads stored temporarily in the bead state storing unit 14 is updated to be OFF (invalid) on the assumption that the selected bead is moved over the abacus.

Thus, it is possible to recognize, as the bead moved over the abacus and the bead placed in an original position, the bead brought into the state of ON (valid) by the movement and the bead brought into the same OFF (invalid) state as the initial state based on the state of each of the beads stored in the bead state storing unit 14. Therefore, it is possible to reproduce the arrangement of the beads at that point or to express the state of the bead in a numeral.

Subsequently, the operator to perform a calculation exercise of mental arithmetic presses down the display mode selection button (“exercise” or “performance”) displayed on the operation screen to select a display mode, that is, an exercise mode or a performance mode. It is preferable that these display modes should be set to replace a displayed mode with another mode when the selection button is pressed down. When the input/output control unit 11 detects that the display mode selection button is pressed down, the selected display mode is temporarily stored in the display mode storing unit 12.

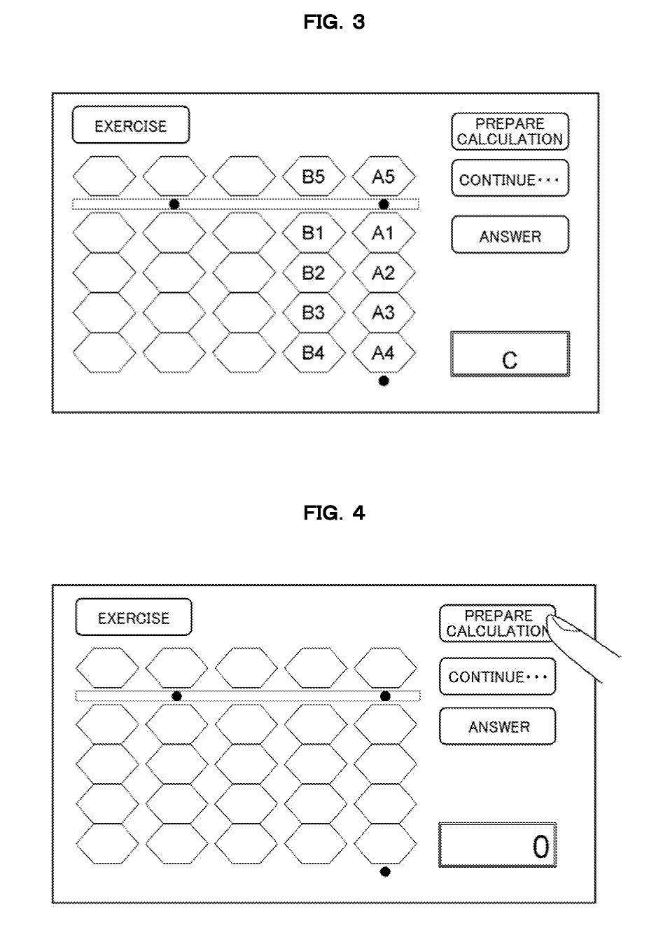

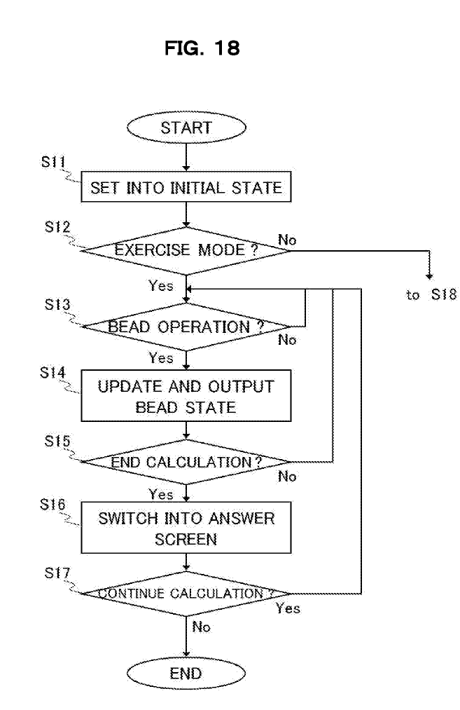

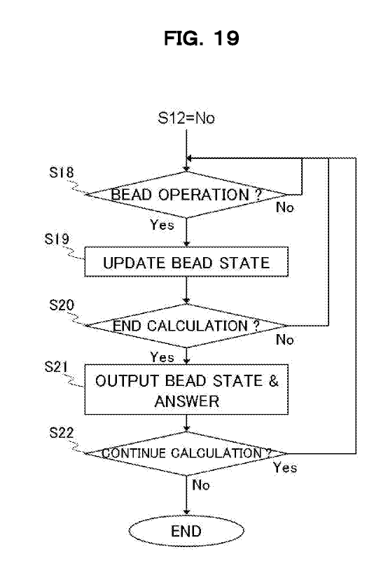

The display mode to be temporarily stored in the display mode storing unit 12 may be switchable from start of one calculation (press-down of “prepare calculation”) to end (press-down of “answer”), that is, in a process of one calculation question or any of the display modes may be fixed during a calculation exercise corresponding to one calculation question. In the following, description will be given by using the flowchart of FIG. 17 and the flowcharts of FIGS. 18 and 19 with former and latter cases set to be a first embodiment and a second embodiment, respectively. As shown in FIG. 3, description will be given on the assumption that a bead in a digit corresponding to a one's place is represented as A5 for a five-bead and A1 to A4 for a one-bead, and a bead in a digit corresponding to a ten's place is represented as B5 for the five-bead and B1 to B4 for the one-bead, and furthermore, an answer display region where a calculation result is output in a numeral is represented as C.

First of all, description will be given to the first embodiment shown in the flowchart of FIG. 17. When the input/output control unit 11 detects that the operator presses down the calculation start button (“prepare calculation”), a calculation exercise corresponding to one calculation question is started. First of all, an initial state is to be set (S01). Specifically, the states of all of the beads stored in the bead state storing unit 14 are to be set into OFF (invalid) of the initial state and all of the beads displayed on the operation screen are to be displayed corresponding to a state in which they are not moved over the abacus (colorless display of the beads in examples of FIGS. 4 to 16 which will be described below).

In a state in which the calculation exercise is started, the operator selects either the exercise mode or the performance mode through the display mode selection button. In an example of a transition of the operation screen shown in FIGS. 4 to 8, there is illustrated a state in which the exercise mode is continuously maintained to be selected. FIG. 4 shows a state in which the calculation start button (“prepare calculation”) is pressed down in the exercise mode.

In this state, a calculation question is given to the operator. How to give a calculation question is not particularly restricted but a question stored in the computer body 10 may be output from the voice output unit 15 to the speaker 30 or a calculation question may be given in an automatic voice or the like from another device separated from the computer body 10, by oral reading of a giver or presenting a question sheet. In a specific example which will be shown below, description will be given on the assumption that a calculation question of “5+8+46 (+20)” is given.

When a calculation question is given and the input/output control unit 11 detects that the operator performs an operation for selecting any of the beads (S02), an arithmetic processing based on the abacus calculation rule is carried out in the arithmetic processing unit 13, the state of each of the beads related to the selected bead is determined to be ON (valid) or OFF (invalid) and the state of each of the beads stored in the bead state storing unit 14 is updated (S03). Subsequently, it is confirmed which one of the exercise mode and the performance mode is selected through the display mode selection button, that is, whether the display mode stored in the display mode storing unit 12 is the exercise mode or the performance mode (S04).

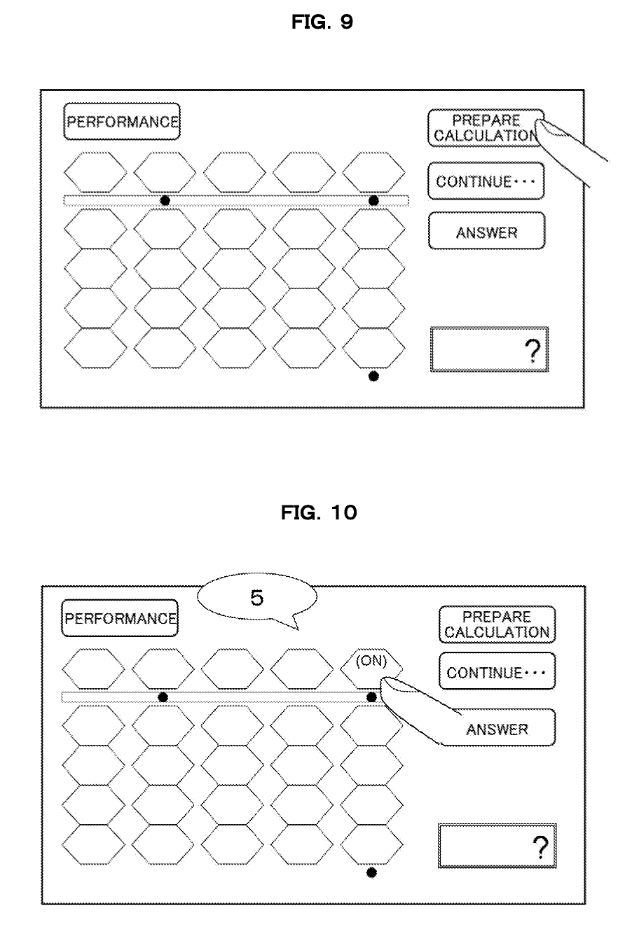

If the exercise mode is selected through the display mode selection button, that is, the display mode stored in the display mode storing unit 12 is set to be the exercise mode, the input/output control unit 11 outputs the display state of the bead to the operation screen of the touch panel 20 so as to be changed in such a manner that the update of the state of the bead having the state updated can be identified over the operation screen (S05). In addition, it is preferable to output, to the operation screen of the touch panel 20, the number determined based on the abacus calculation rule from the arrangement of the beads to be specified by the states of all of the beads at that point. A flow in the case in which the performance mode is selected will be described later with reference to FIGS. 9 to 13.

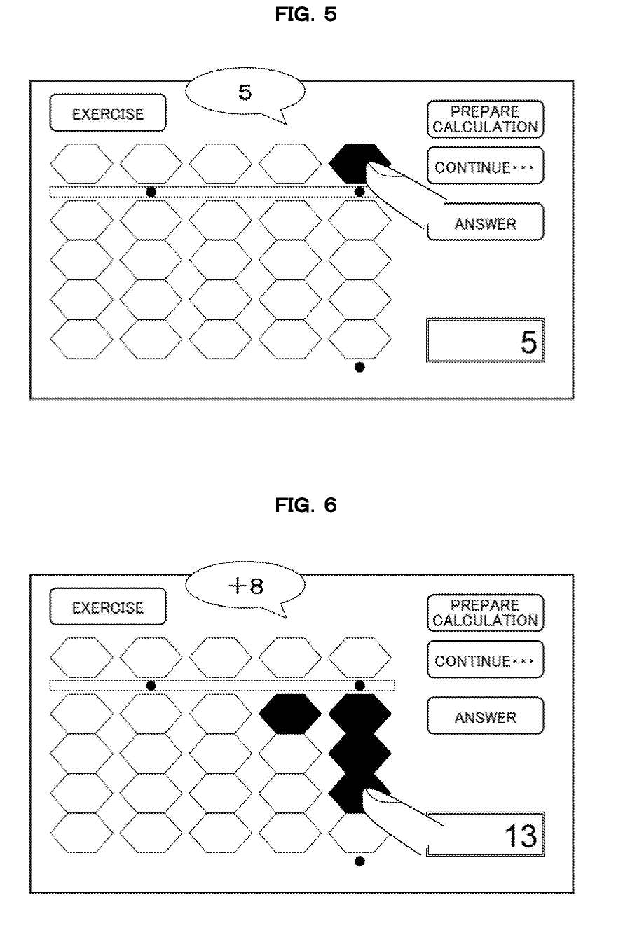

In the example of FIG. 5, there is illustrated a state in which a number of “5” is shown in the state of the calculation start in the exercise mode illustrated in the example of FIG. 4 and the bead of A5 representing “5” in the abacus is selected. At this time, the state of the bead of A5 which was OFF (invalid) of the initial state is determined to be ON (valid) and the state of the bead of A5 stored in the bead state storing unit 14 is updated from OFF (invalid) to ON (valid). In addition, the bead of A5 on the operation screen is changed from a colorless state to a coloring state. In replacement with the abacus, it is possible to identify that only this bead is placed in a moved position. Furthermore, the number of “5” indicated by the arrangement of this bead is displayed on an answer display region C.

Herein, a method capable of identifying a bead moved in the replacement with the abacus, that is, a method capable of identifying, on the operation screen, a bead in the state of ON (valid) and a bead in the state of OFF (invalid) is not restricted to a method of performing identification depending on a difference in a color, that is, colorless or coloring with the position of a bead maintained as it is but the position of the bead may be moved in the same manner as in the abacus, for example. In addition, it is also possible to employ a method of performing identification depending on a difference, that is, a change of halftone dot meshing or an outer frame into a thick line or the like as well as the coloring with the position of the bead maintained as it is.

When the operation for selecting a bead is further detected after the change in the state of the bead is output, the same processing is repeated. In the example of FIG. 6, there is illustrated a state in which a calculation of “+8” is subsequently shown with the exercise mode selected consecutively and the beads of B1, A5 and A3 are selected as an operation corresponding to an operation for setting “5+8=13” through the abacus. Consequently, the states of the beads of B1 and A1 to A3 which were OFF (invalid) of the initial state are determined to be ON (valid), and the states of these beads stored in the bead state storing unit 14 are updated from OFF (invalid) to ON (valid). On the other hand, the state of the bead of A5 which was changed into the state of ON (valid) is determined to be OFF (invalid), and the state of the bead of A5 stored in the bead state storing unit 14 is updated from ON (valid) to OFF (invalid). In addition, these beads on the operation screen are changed from the colorless state to the coloring state or from the coloring state to the colorless state. Consequently, the arrangement of the beads in replacement with the abacus can be recognized over the operation screen. Furthermore, the number of “13” indicated by the arrangement of the beads is displayed on the answer display region C.

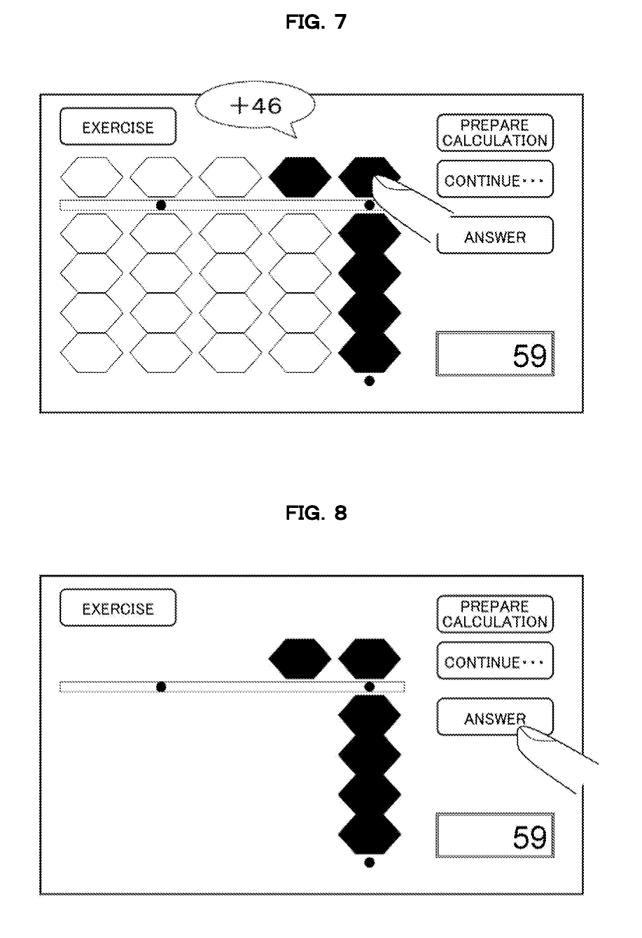

In the example of FIG. 7, there is illustrated a state in which a calculation of “+46” is further shown with the exercise mode selected consecutively and the beads of B5, B1, A5 and A4 are selected as an operation corresponding to an operation for setting “13+46=59” through the abacus. Consequently, the states of the beads of B5, A5 and A4 which were OFF (invalid) are determined to be ON (valid) and the states of these beads stored in the bead state storing unit 14 are updated from OFF (invalid) to ON (valid). On the other hand, the state of the bead of B1 which was changed into the state of ON (valid) is determined to be OFF (invalid) and the state of the bead of B1 stored in the bead state storing unit 14 is updated from ON (valid) to OFF (invalid). In addition, these beads on the operation screen are changed from the colorless state to the coloring state or from the coloring state to the colorless state, and the arrangement of the beads in replacement with the abacus can be recognized over the operation screen. Furthermore, the number of “59” indicated by the arrangement of the beads is displayed on the answer display region C.

The related state of a certain bead in the case of the selection of the bead is determined based on the abacus calculation rule. In the case in which the selected bead is a five-bead, specifically, it is preferable to determine the state of the selected bead to be ON (valid) if it is OFF (invalid) and to be OFF (invalid) if the state of the selected bead is ON (valid). In the case in which the selected bead is a one-bead, it is preferable to determine the state of the bead in order to set the selected bead and a one-bead in the same digit placed in an upper position of the selected bead to be ON (valid) if the state of the selected bead is OFF (invalid) and to set the selected bead and a one-bead in the same digit placed in a lower position of the selected bead to be OFF (invalid).

According to this logic, even if it is impossible to detect a difference made by moving the bead upward or downward by the operation performed through the touch panel 20, it is possible to determine the state of each bead based on the abacus calculation rule by simply recognizing which bead is selected. This respect is the same as in the state in which a performance mode to be described later is selected.

When a calculation question is completely given to request an answer, the operator presses down the calculation end button (“answer”) on the operation screen. When the input/output control unit 11 detects this operation (S06), a processing for switching the operation screen of the touch panel 20 into an answer screen is performed (S07). FIG. 8 shows an example of the answer screen indicative of an answer to a calculation question. The answer screen is not restricted to this example. When there is performed switching into a screen on which only a bead corresponding to a moved bead is displayed in replacement with the abacus as in this example, however, the answer can easily be recognized at a first glance.

When the answer screen is output as described above, a calculation exercise corresponding to one calculation question is ended if the calculation continue button (“continue . . . ”) is not pressed down (S08). If the calculation continue button is pressed down, the same processing (S02 to S07) is further continued in accordance with the selection of the bead by the operator based on the state of the bead when the answer is indicated. The details of a calculation continuing method will be described in detail in the following explanation of the performance mode.

The description has been given to the example in which the exercise mode is selected through the display mode selection button, that is, the display mode stored in the display mode storing unit 12 is the exercise mode in S04. The following processing is performed in the case in which the performance mode is selected through the display mode selection button, that is, the display mode stored in the display mode storing unit 12 is set to be the performance mode. If the exercise mode is selected, a processing (S05) for performing output to change the display state of the bead is executed over the operation screen of the touch panel 20. In the case in which the performance mode is selected, this processing is not executed and a state brought before the detection of the operation for selecting the bead in S02 is maintained over the operation screen of the touch panel 20. In other words, the performance mode features that display of the bead on the operation screen of the touch panel 20 is not changed and the number to be determined based on the abacus calculation rule is not displayed even if the state of the bead stored in the bead state storing unit 14 is updated.

In the example of FIG. 10, there is illustrated a state in which the number of “5” is shown in the state of the calculation start in the performance mode illustrated in the example of FIG. 9 and the same operation as that in the example of FIG. 5 in the exercise mode is performed. The state of the bead of A5 which was OFF (invalid) in the initial state is determined to be ON (valid) and the state of the bead of A5 stored in the bead state storing unit 14 is updated from OFF (invalid) to ON (valid) in the same manner. However, the bead of A5 on the operation screen is maintained to be colorless and is not changed (Although FIG. 10 shows that the state of the bead of A5 is changed into ON conveniently, the display of the bead of A5 on the operation screen is not changed at all). Furthermore, the number of “5” indicated by the arraignment of the beads is not displayed on the answer display region C. At this point, a calculation result is non-displayed.

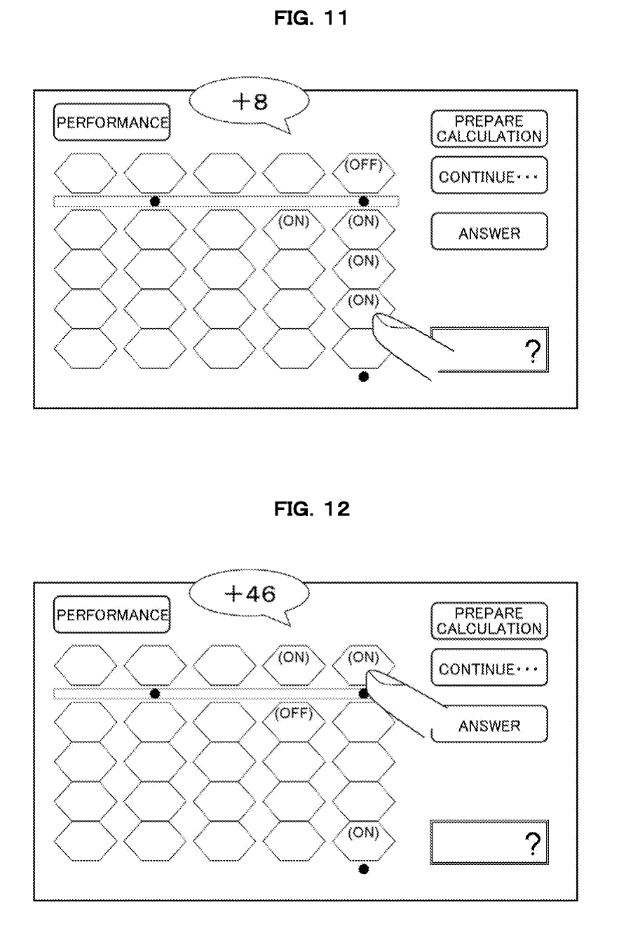

When the operation for selecting the bead is further detected after the state of the bead is updated, the same processing is repeated. In an example of FIG. 11, there is illustrated a state in which the calculation of “+8” is shown in the same manner as in the example of FIG. 6 with the performance mode is maintained to be selected consecutively and the beads of B1, A5 and A3 are selected as an operation corresponding to an operation for setting “5+8=13” through an abacus. Similarly, the states of the beads of B1 and A1 to A3 which were OFF (invalid) in the initial state are determined to be ON (valid), the states of these beads stored in the bead state storing unit 14 are updated from OFF (invalid) to ON (valid), the state of the bead of A5 which was changed into the state of ON (valid) is determined to be OFF (invalid), and the state of the bead of A5 stored in the bead state storing unit 14 is updated from ON (valid) to OFF (invalid). However, the display of these beads on the operation screen is not changed and the number of “13” indicated by the arrangement of the beads is not displayed on the answer display region C. At this point, a calculation result is non-displayed.

In an example of FIG. 12, there is illustrated a state in which the calculation of “+46” is shown in the same manner as in the example of FIG. 7 with the performance mode is maintained to be selected consecutively and the beads of B5, B1, A5 and A4 are selected as an operation corresponding to an operation for setting “13+46=59” through the abacus. Similarly, the states of the beads of B5, B1, A5 and A4 which were OFF (invalid) are determined to be ON (valid), the states of these beads stored in the bead state storing unit 14 are updated from OFF (invalid) to ON (valid), and the state of the bead of B1 which was changed into the state of ON (valid) is determined to be OFF (invalid), and the state of the bead of B1 stored in the bead state storing unit 14 is updated from ON (valid) to OFF (invalid). However, the display of these beads on the operation screen is not changed, the number of “59” indicated by the arrangement of the beads is not displayed on the answer display region C, and a calculation result at this point is non-displayed.

As described above, the present invention features that the display of the bead on the operation screen of the touch panel 20 is not changed and the number to be determined based on the abacus calculation rule is not displayed even if the state of the bead stored in the bead state storing unit 14 is updated when the performance mode is selected. However, there is also a possibility that the operator cannot recognize which one of the beads is selected. In the case in which the input/output control unit 11 detects the operation for selecting the bead, therefore, it is preferable to enable identification by instantly developing the color of the bead selected on the operation screen or output a sound capable of identifying the selected bead from the voice output unit 15 to the speaker 30.

When a calculation question is completely given to request an answer, the operator presses down the calculation end button (“answer”) over the operation screen. When the input/output control unit 11 detects this operation (S06), it outputs, as an answer screen, display in which the state of the bead can be identified to the operation screen of the touch panel 20 in such a manner that the states of the respective beads in calculation end can be identified on the operation screen and outputs, to the operation screen of the touch panel 20, the number to be determined based on the abacus calculation rule from the arrangement of the beads to be specified by the states of all of the beads at that point (S07).

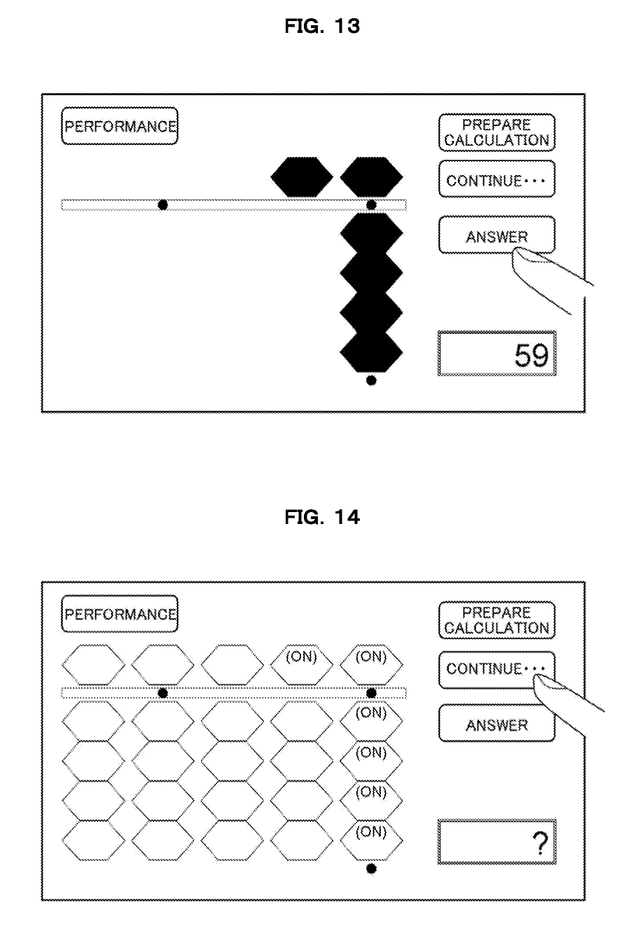

FIG. 13 shows an example of the answer screen indicative of an answer to a calculation question with the performance mode maintained to be selected. The answer screen is not restricted to this example. However, in the performance mode, the answer screen is displayed in the state of each bead in this stage, that is, a state in which the bead corresponding to the moved bead can be identified in replacement with the abacus, and the number indicated by the arrangement of the beads is also displayed on the answer display region C. A method of enabling the identification of the moved bead in replacement with the abacus is not restricted to a method of performing the identification depending on a difference in a color, that is, whether a position of the bead is exactly colorless or colored as shown in herein in the same manner as in the case in which the answer screen is output in the exercise mode.

When the answer screen is output as described above, a calculation exercise corresponding to one calculation question is ended if the calculation continue button (“continue . . . ”) is not pressed down (S08). If the calculation continue button is pressed down, the same processing (S02 to S07) is continued based on the state of the bead at a time that an answer is indicated, and furthermore, in accordance with the selection of the bead by the operator.

FIGS. 14 to 16 show an example of the case in which the calculation continue button is pressed down. As in the example of FIG. 14, however, when the calculation continue button is pressed down in a state in which the performance mode is maintained to be selected, the display of the operation screen is returned to a state brought before the answer screen is output, and the state of each bead stored in the bead state storing unit 14 is not returned into the initial state but the state in the output of the answer screen is maintained as it is.

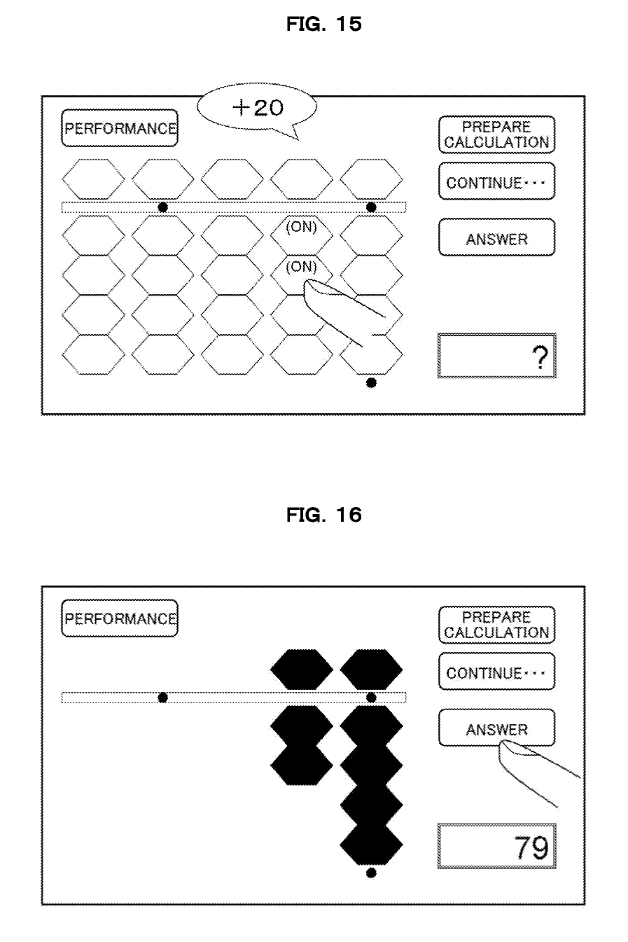

As in the example of FIG. 15, the calculation of “+20” is further shown and the bead of B2 is selected as an operation corresponding to the operation for setting “59+20=79” through the abacus in a state in which the performance mode is maintained to be selected. The states of the beads of B1 and B2 which were OFF (invalid) are determined to be ON (valid) and the states of these beads stored in the bead state storing unit 14 are updated from OFF (invalid) to ON (valid). However, the display of these beads on the operation screen is not changed and the number of “79” indicated by the arraignment of the beads is not displayed on the answer display region C and a calculation result at this point is non-displayed.

When it is detected that the calculation end button (“answer”) is pressed down in this state, the display is performed in the state of each bead in the press-down of the end button, that is, a state in which the bead corresponding to the moved bead can be identified in replacement with the abacus and the number indicated by the arrangement of the beads is output as in the example of FIG. 16 in the same manner as shown in the example of FIG. 13.

The function for continuing a calculation which can be performed through the calculation continue button may be used when giving a certain calculation question and then giving another calculation question to be calculated based on a number to be an answer to the question, for example, or may be used in order to once interrupt the calculation and confirm the number when a calculation result is to be confirmed in a middle stage in a calculation process of the calculation question.

Even if the display mode selected in the output of the calculation result is either the exercise mode or the performance mode, a calculation exercise corresponding to one calculation question is ended if the calculation continue button (“continue . . . ”) is not pressed down (S08). Thereafter, it is sufficient that the states of all of the beads stored in the bead state storing unit 14 are returned into the initial state in a stage in which the input/output control unit 11 subsequently detects that the calculation start button (“prepare calculation”) is pressed down. However, an operation for initializing the state of the bead is not restricted to the press-down of the calculation start button. For example, it is also possible to decide that the continuation of the calculation should not be performed when a certain time passes since the output of the answer screen, thereby returning, into the initial state, the states of all of the beads stored in the bead state storing unit 14.

In FIGS. 5 to 7 and FIGS. 10 to 12, the description has been given to the examples in which the calculation exercise is continued in the state in which the exercise mode or the performance mode are maintained to be selected respectively while the same calculation exercise is performed. However, it is also possible to switch the exercise mode and the performance mode by pressing down the display mode selection button in the middle of a one-time calculation exercise. In that case, a change in the state of the bead is displayed or is not displayed depending on which display mode is selected when accepting an operation for selecting the bead to update the state of the bead. For example, a transition is made over the operation screen in order of FIGS. 5, 11 and 7 by switching in order of the exercise mode, the performance mode and the exercise mode and is made over the operation screen in order of FIGS. 10, 6 and 12 by switching in order of the performance mode, the exercise mode and the performance mode. By enabling such switching, it is possible to advance the calculation exercise while switching display and non-display in the middle of a calculation exercise corresponding to one calculation question in adaptation to a skill of a learner. Therefore, the present invention is particularly suitable for effectively learning the abacus calculation type mental arithmetic.

Flowcharts of FIGS. 18 and 19 show a processing flow according to a second embodiment in which any display mode is fixed during a calculation exercise corresponding to one calculation question in contrast with the first embodiment in which the switching of the display mode can be performed during the calculation exercise corresponding to one calculation question described above. Also in the second embodiment, when the input/output control unit 11 detects that the operator presses down the calculation start button, a calculation exercise corresponding to one calculation question is started. First of all, the initial state is set (S11). Specifically, the states of all of the beads stored in the bead state storing unit 14 are set to be OFF (invalid) in the initial state and all of the beads displayed on the operation screen are also displayed corresponding to a state in which the beads are not moved over the abacus.

Next, it is confirmed which one of the exercise mode and the performance mode is selected, that is, whether the display mode stored in the display mode storing unit 12 is the exercise mode or the performance mode (S12). When a calculation question is given in a state in which the exercise mode is selected and the input/output control unit 11 detects that the operator performs the operation for selecting any of the beads (S13), the arithmetic processing unit 13 performs an arithmetic processing based on the abacus calculation rule to determine the state of each bead related to the selected bead to be set into ON (valid) or OFF (invalid), thereby updating the state of each bead stored in the bead state storing unit 14, and furthermore, the input/output control unit 11 outputs a change in the display of the bead to the operation screen of the touch panel 20 in such a manner that a change in the state of the bead having the state updated can be identified on the operation screen (S14). In addition, it is preferable that the number to be determined based on the abacus calculation rule from the arrangement of the beads to be specified by the states of all of the beads at that point should also be output to the operation screen of the touch panel 20. When the operation for selecting the bead is further detected after the change in the state of the bead is output (S13), the same processing (S14) is repeated.

When a calculation question is completely given to request an answer, the operator presses down the calculation end button (“answer”) on the operation screen. When the input/output control unit 11 detects this operation (S15), there is performed a processing for switching the operation screen of the touch panel 20 into the answer screen (S16). The examples shown in FIGS. 4 to 8 exactly correspond to the transition of the operation screen up to here.

When the answer screen is output, the calculation exercise corresponding to one calculation question is ended if the calculation continue button (“continue . . . ”) is not pressed down (S17). If the calculation continue button is pressed down, the same processing (S13 to S16) is further continued in accordance with the selection of the bead by the operator based on the state of the bead at a time that an answer is indicated. The details of a calculation continuing method are the same as those in the first embodiment.

The flowchart of FIG. 19 shows a processing flow in the case in which the performance mode is selected in the second embodiment. When a calculation question is given and the input/output control unit 11 detects that the operator performs the operation for selecting any of the beads (S18), the arithmetic processing unit 13 performs an arithmetic processing based on the abacus calculation rule to determine the state of each bead related to the selected bead to be ON (valid) or OFF (invalid), thereby updating the state of each bead stored in the bead state storing unit 14 (S19). The performance mode features that the display of the bead on the operation screen of the touch panel 20 is not changed and the number to be determined based on the abacus calculation rule is not displayed even if the state of the bead stored in the bead state storing unit 14 is thus updated. When the operation for selecting the bead is further detected after the change in the state of the bead is output (S18), the same processing (S19) is repeated.

When a calculation question is completely given to request an answer, the operator presses down the calculation end button (“answer”) on the operation screen. When the input/output control unit 11 detects this operation (S20), it outputs, to the operation screen of the touch panel 20, such display that the state of the bead can be identified in such a manner that the state of each bead in the calculation end can be identified over the operation screen, and furthermore, outputs, to the operation screen of the touch panel 20, the number to be determined based on the abacus calculation rule from the arrangement of the beads to be specified by the states of all of the beads at that point (S21). The examples shown in FIGS. 9 to 13 exactly correspond to the transition of the operation screen up to here.

When the answer screen is output, the calculation exercise corresponding to one calculation question is ended if the calculation continue button (“continue . . . ”) is not pressed down (S22). If the calculation continue button is pressed down, the same processing (S18 to S21) is further continued in accordance with the selection of the bead by the operator based on the state of the bead at a time that an answer is indicated. The details of the calculation continuing method are the same as those in the first embodiment.

Also in the processing flows of the flowcharts of FIGS. 18 and 19, if the calculation continue button (“continue . . . ”) is not pressed down (S17, S22), the calculation exercise corresponding to one calculation question is ended. Thereafter, it is preferable to return the states of all of the beads stored in the bead state storing unit 14 into the initial states in a stage in which the input/output control unit 11 subsequently detects that the calculation start button (“prepare Calculation”) is pressed down. However, the operation for initializing the state of the bead is not restricted to the press-down of the calculation start button but it is also possible to decide that the continuation of the calculation is not performed after a certain time passes since the output of the answer screen, thereby returning the states of all of the beads stored in the bead state storing unit 14 into the initial states in the same manner as in the first embodiment.

Although the description has been given to both of the first and second embodiments on the assumption that the exercise mode and the performance mode can be switched, the present invention can also be carried out without the exercise mode provided and with restriction to only the function of the performance mode in which the bead corresponding to the moved bead is not displayed in an identification enabling state in replacement with the abacus until a transition to the answer screen is made and the number indicated by the arrangement of the beads is also non-displayed.

### EXPLANATION OF DESIGNATIONS

10 computer body
11 input/output control unit
12 display mode storing unit
13 arithmetic processing unit
14 bead state storing unit
15 voice output unit
20 touch panel
30 speaker

1. An abacus calculation type mental arithmetic learning support device comprising:
operation screen output means for outputting an abacus-like operation screen capable of recognizing selection of each bead to a touch panel;
bead state storing means for determining and storing a state of each bead into an invalid or valid state based on an abacus calculation rule when accepting a calculation stating operation and then recognizing selection of any bead displayed on the operation screen; and
bead state output means for outputting the state of the bead to the operation screen in such a manner that a difference in the state of the bead stored in the bead state storing means can be identified visually,
the bead state output means maintaining a state in which the difference in the state of each bead stored in the bead state storing means cannot be identified visually on the operation screen before accepting an operation for ending the calculation from the calculation starting operation and outputting the state of each bead to the operation screen in such a manner that the difference in the state of each bead stored in the bead state soring means can be identified visually when accepting the calculation ending operation.

2. The abacus calculation type mental arithmetic learning support device according to claim 1, further comprising:
calculation result output means for outputting a number to be determined from states of all of beads stored in the bead state storing means as a calculation result to the operation screen,
wherein the calculation result output means maintains a state in which a number to be determined from the states of all of the beads stored in the bead state storing means is not displayed on the operation screen before accepting the calculation ending operation from the calculation starting operation and outputs the number to be determined from the states of all of the beads stored in the bead state storing means as a calculation result to the operation screen when accepting the calculation ending operation.

3. The abacus calculation type mental arithmetic learning support device according to claim 1, further comprising:
display mode storing means for accepting and storing selection of a display mode, that is, an exercise mode or a performance mode;
wherein the bead state output means outputting the state of the bead to the operation screen in such a manner that a difference in the state of the bead can be identified visually if the exercise mode is stored in the display mode storing means when the state of the bead stored in the bead state storing means is changed, maintaining a state in which a difference in the state of each bead stored in the bead state storing means cannot be identified visually on the operation screen if the performance mode is stored in the display mode storing means, and outputting the state of each bead to the operation screen in such a manner that the difference in the state of the bead stored in the bead state storing means can be identified visually even if either the exercise mode or the performance mode is stored in the display mode storing means when accepting the calculation ending operation.

4. The abacus calculation type mental arithmetic learning support device according to claim 3, further comprising:
calculation result output means for outputting a number to be determined from the states of all of the beads stored in the bead state storing means as a calculation result to the operation screen,
the calculation result output means outputting a number to be determined from states of all of the beads stored in the bead state storing means as a calculation result to the operation screen if the exercise mode is stored in the display mode storing means when the state of the bead stored in the bead state storing means is changed, maintaining a state in which the number to be determined from the states of all of the beads stored in the bead state storing means is not displayed on the operation screen if the performance mode is stored in the display mode storing means, and outputting the number to be determined from the states of all of the beads stored in the bead state storing means as a calculation result to the operation screen even if either the exercise mode or the performance mode is stored in the display mode storing means when accepting the calculation ending operation.

5. The abacus calculation type mental arithmetic learning support device according to claim 1,
wherein the bead state storing means determines and stores the state of the bead to be valid if the state of the selected bead is invalid and to be invalid if the state of the selected bead is valid when the selected bead is a five-bead, and determines and stores the state of the selected bead and a one-bead in the same digit placed in an upper position of the selected bead to be valid if the state of the selected bead is invalid, and the state of the selected bead and a one-bead in the same digit placed in a lower position of the selected bead to be invalid if the state of the selected bead is valid when the selected bead is a one-bead.

6. The abacus calculation type mental arithmetic learning support device according to claim 1, further comprising:
bead state initializing means for returning a state of each bead stored in the bead state storing means into initialization when accepting a predetermined operation for initializing a state of a bead including a new calculation starting operation,
the bead state storing means determining and storing a state of each bead based on an abacus calculation rule when selection of any of the beads displayed on the operation screen is recognized after a calculation continuing operation is accepted with the state of each bead which is stored in the acceptance of a calculation ending operation set to be an origin if the calculation continuing operation is accepted after the calculation ending operation is accepted.

7. The abacus calculation type mental arithmetic learning support device according to claim 1, further comprising:
operation sound output means for outputting, to a speaker, an operation sound corresponding to the selected bead when selection of any of the beads displayed on the operation screen is recognized after the calculation starting operation is accepted.

8. The abacus calculation type mental arithmetic learning support device according to claim 1, further comprising:
bead display changing means for temporarily changing a display state of the selected bead in such a manner that the selected bead can be identified visually when selection of any of the beads displayed on the operation screen is recognized after the calculation starting operation is accepted.

9. An abacus calculation type mental arithmetic learning support program stored on a non-transitory computer readable medium, wherein a computer for inputting/outputting information by using a touch panel is caused to function as:
operation screen output means for outputting an abacus-like operation screen capable of recognizing selection of each bead to the touch panel;
bead state storing means for determining and storing a state of each bead into an invalid or valid state based on an abacus calculation rule when accepting a calculation stating operation and then recognizing selection of any bead displayed on the operation screen; and
bead state output means for outputting the state of the bead to the operation screen in such a manner that a difference in the state of the bead stored in the bead state storing means can be identified visually,
the bead state output means maintaining a state in which the difference in the state of each bead stored in the bead state storing means cannot be identified visually over the operation screen before accepting an operation for ending the calculation from the calculation starting operation and outputting the state of each bead to the operation screen in such a manner that the difference in the state of each bead stored in the bead state soring means can be identified visually when accepting the calculation ending operation.

10. The abacus calculation type mental arithmetic learning support program according to claim 9, wherein a computer for inputting/outputting information by using a touch panel is caused to further function as:
display mode storing means for accepting and storing selection of a display mode, that is, an exercise mode or a performance mode;
wherein the bead state output means outputting the state of the bead to the operation screen in such a manner that a difference in the state of the bead can be identified visually if the exercise mode is stored in the display mode storing means when the state of the bead stored in the bead state storing means is changed, maintaining a state in which a difference in the state of each bead stored in the bead state storing means cannot be identified visually on the operation screen if the performance mode is stored in the display mode storing means, and outputting the state of each bead to the operation screen in such a manner that the difference in the state of the bead stored in the bead state storing means can be identified visually even if either the exercise mode or the performance mode is stored in the display mode storing means when accepting an operation for ending the calculation.

11. An abacus calculation type mental arithmetic learning support method, wherein a computer for inputting/outputting information by using a touch panel has:
an operation screen outputting step of outputting an abacus-like operation screen capable of recognizing selection of each bead to the touch panel;
a bead state storing step of determining and storing a state of each bead into an invalid or valid state based on an abacus calculation rule when accepting a calculation stating operation and then recognizing selection of any bead displayed on the operation screen; and
a bead state outputting step of outputting the state of the bead to the operation screen in such a manner that a difference in the state of the bead stored at the bead state storing step can be identified visually,
at the bead state outputting step, the computer maintains a state in which the difference in the state of each bead stored at the bead state storing step cannot be identified visually over the operation screen before accepting a calculation ending operation from a calculation starting operation and outputs the state of each bead to the operation screen in such a manner that the difference in the state of each bead stored at the bead state storing step can be identified visually when accepting the calculation ending operation.

12. The abacus calculation type mental arithmetic learning support method according to claim 11, wherein a computer for inputting/outputting information by using a touch panel further has:
a display mode storing step of accepting and storing selection of a display mode, that is, an exercise mode or a performance mode;
at the bead state outputting step, the computer outputs the state of the bead to the operation screen in such a manner that a difference in the state of the bead can be identified visually if the exercise mode is stored at the display mode storing step when the state of the bead stored at the bead state storing step is changed, maintains a state in which a difference in the state of each bead stored in the bead state storing means cannot be identified visually over the operation screen if the performance mode is stored at the display mode storing step, and outputs the state of the bead to the operation screen in such a manner that the difference in the state of the bead stored at the bead state storing step can be identified visually even if either the exercise mode or the performance mode is stored at the display mode storing step when accepting the calculation ending operation.

13. The abacus calculation type mental arithmetic learning support device according to claim 3,
wherein the bead state storing means determines and stores the state of the bead to be valid if the state of the selected bead is invalid and to be invalid if the state of the selected bead is valid when the selected bead is a five-bead, and determines and stores the state of the selected bead and a one-bead in the same digit placed in an upper position of the selected bead to be valid if the state of the selected bead is invalid, and the state of the selected bead and a one-bead in the same digit placed in a lower position of the selected bead to be invalid if the state of the selected bead is valid when the selected bead is a one-bead.

14. The abacus calculation type mental arithmetic learning support device according to claim 3, further comprising:
bead state initializing means for returning a state of each bead stored in the bead state storing means into initialization when accepting a predetermined operation for initializing a state of a bead including a new calculation starting operation,
the bead state storing means determining and storing a state of each bead based on an abacus calculation rule when selection of any of the beads displayed on the operation screen is recognized after a calculation continuing operation is accepted with the state of each bead which is stored in the acceptance of a calculation ending operation set to be an origin if the calculation continuing operation is accepted after the calculation ending operation is accepted.

15. The abacus calculation type mental arithmetic learning support device according to claim 3, further comprising:
operation sound output means for outputting, to a speaker, an operation sound corresponding to the selected bead when selection of any of the beads displayed on the operation screen is recognized after the calculation starting operation is accepted.

16. The abacus calculation type mental arithmetic learning support device according to claim 3, further comprising:
bead display changing means for temporarily changing a display state of the selected bead in such a manner that the selected bead can be identified visually when selection of any of the beads displayed on the operation screen is recognized after the calculation starting operation is accepted.
